(19) United States
(12) Patent Application Publication
(10) Pub. No.: US 2026/0349235 A1
(43) Pub. Date: Nov. 5, 2026

(54) A COMPUTATIONAL MICROSCOPY METHOD AND SYSTEM FOR VOLUMETRIC IMAGING

(71) Applicant: AUSTRALIAN NATIONAL UNIVERSITY, Australian Capital Territory (AU)

(72) Inventors: Woei Ming LEE, Australian Capital Territory (AU); Tienan XU, Australian Capital Territory (AU)

(73) Assignee: AUSTRALIAN NATIONAL UNIVERSITY, Australian Capital Territory (AU)

(21) Appl. No.: 19/099,262

(22) PCT Filed: Jul. 28, 2023
(86) PCT No.: PCT/AU2023/050712

§ 371 Date: Jan. 28, 2025

(30) Foreign Application Priority Data
Jul. 28, 2022 (AU) 2022902123

(51) Int. Cl. G02B 21/36; G02B 21/00; G02B 30/52

(52) U.S. Cl. CPC G02B 21/367; G02B 21/0032; G02B 21/0076; G02B 21/008; G02B 30/52

(57) ABSTRACT

A microscopy method for volumetric imaging of a sample located within an object space, comprising: obtaining a set of lightfield images using a lightfield detection apparatus, each associated with an illumination slice corresponding to a lightsheet projected into the object space from a particular illumination position and at an illumination angle non-parallel to an optical axis of the lightfield detection apparatus, such that each voxel of a set of voxels associated with the object space is illuminated by at least one illumination slice, wherein each voxel is defined by a position in the object space; and determining, for each voxel, an intensity of light emitted from the object space associated with said voxel using, in part, angular information captured by the lightfield images, such that the determined intensities for each voxel of the set of voxels defines a volumetric image of emitted light intensity within the object space, and associated system.

### FIELD OF THE INVENTION

The present invention generally relates microscopy systems and methods for volumetric imaging of an object space in a sample.

### BACKGROUND TO THE INVENTION

There are known various methods of three-dimensional or volumetric imaging, for example confocal laser scanning microscopy and the like which are used to image biological samples. Subsequently, lightsheet microscopy has been developed where a sample is moved through a plane of light to effect optical sectioning of the sample. Single objective scanning lightsheet using oblique plane (OP) illumination techniques, where the lightsheet is at a non-incidence angle, have recently pushed the limits of image-based biological studies.

A major disadvantage of using a single objective scanning lightsheet is the requirement of costly and complex remote imaging units that comprise two complementary objective lenses (secondary and tertiary objective lenses) to achieve the necessary diffraction limited imaging and optical sectioning. Further, additional elements such as scanning mirrors, diffraction grating, or tailor-made prisms are required to de-skew and replicate a 3D volume image on a 2D imaging sensor. More importantly, these remote focusing units are incompatible with standard imaging detection schemes which typically comprise a single tube lens with 2D camera sensor. As such, single objective scanning lightsheet systems (e.g., eSPIM and SCAPE) are only limited to specialized microscopy setups.

Lightfield is a special class of single-shot volumetric fluorescence imaging that focuses on computational imaging that perform 3D depth retrieval using a single 2D lightfield image data. There are a range of lightfield computational tools are designed to identify 3D information (x, y, z) of an object based on the angular disparity (r, θ) that is encoded within lightfield images generated by a microlens array. However current lightfield techniques are not sufficiently sophisticated to deal with the challenges of lightsheet systems using oblique plane illumination techniques with standard detection schemes.

It is desirable for embodiments of the present invention to address at least partially one or more of the disadvantages of the methods or systems above. Further it is desirable that embodiments of the present invention provide a method or system of retrieving volumetric information from oblique plane illumination techniques. In particular it is preferred that embodiments of the present invention provide a method or system of retrieving volumetric information from oblique plane light sheet illumination techniques with standard imaging detection microscopy apparatus setups.

Reference herein to background art is not an admission that the art forms a part of the common general knowledge of the person skilled in the art, in Australia or any other country.

### SUMMARY OF THE INVENTION

According to an aspect of the present disclosure, there is provided a microscopy method for volumetric imaging of a sample located within an object space, comprising: obtaining a set of lightfield images using a lightfield detection apparatus, each associated with an illumination slice corresponding to a lightsheet projected into the object space from a particular illumination position and at an illumination angle non-parallel to an optical axis of the lightfield detection apparatus, such that each voxel of a set of voxels associated with the object space is illuminated by at least one illumination slice, wherein each voxel is defined by a position in the object space; and determining, for each voxel, an intensity of light emitted from the object space associated with said voxel using, in part, angular information captured by the lightfield images, such that the determined intensities for each voxel of the set of voxels defines a volumetric image of emitted light intensity within the object space.

According to another aspect of the present disclosure, there is provided a microscopy system for volumetric imaging of an object space of a sample, the system comprising a lightfield detection apparatus in communication with a computer having a processor and a memory: the lightfield detection apparatus comprising optical elements being configured to: scan a plane of light at a plurality of positions to thereby produce a plurality of illuminating slices, each associated with a unique position, wherein the plane of light formed from a laser light source at an illumination angle relative to an optical axis for illumination of the object space, such that each voxel of a set of voxels associated with the object space is illuminated by at least one illumination slice, wherein each voxel is defined by a position in the object space; and image the object space for each illumination slice to thereby generate corresponding lightfield images for each illumination slice; and the processor being adapted to execute a plurality of modules stored in the memory, each module being able to execute a set of instructions, wherein the modules are configured to: determine, for each voxel, an intensity of light emitted from the object space associated with said voxel using, in part, angular information captured by the lightfield images, such that the determined intensities for each voxel of the set of voxels defines a volumetric image of emitted light intensity within the object space.

According to another aspect of the present disclosure, there is provided a computer readable storage medium for generating a volumetric image that stores instructions which, when executed by one or more processors of a computer, cause the computer to execute a plurality of modules stored in a memory, each module being able to execute a set of instructions, and wherein the modules comprise: obtaining a set of lightfield images using a lightfield detection apparatus, each associated with an illumination slice corresponding to a lightsheet projected into the object space from a particular illumination position and at an illumination angle non-parallel to an optical axis of the lightfield detection apparatus, such that each voxel of a set of voxels associated with the object space is illuminated by at least one illumination slice, wherein each voxel is defined by a position in the object space; and determining, for each voxel, an intensity of light emitted from the object space associated with said voxel using, in part, angular information captured by the lightfield images, such that the determined intensities for each voxel of the set of voxels defines a volumetric image of emitted light intensity within the object space.

Optionally, the method further comprises: scanning a lightsheet at a plurality of positions to illuminate the object space, such that each position is associated with an illumination slice corresponding to the lightsheet; and imaging the object space when illuminated by each illumination slice to generate the set of voxels. Each voxel may be associated with a depth in the object space. The depth may be a direction lateral to the optical axis.

The lightfield detection apparatus preferably comprises a microlens array for generating the lightfield images. The method may therefore comprise positioning the microlens array at an image plane. Each microlens of the array may have imaging side NA which is less than the NA of the microlens array.

A scanning direction may be a direction lateral to the angle of the plane of light. The illumination positions may be stepped at a constant step size when generating the set of lightfield images.

In an embodiment, the illumination angle is adjustable such that each lightfield image is associated with a unique combination of illumination position and illumination angle.

Optionally, determining the intensity of light emitted from the object space associated with said voxel includes summing adjacent intensities within a predefined axial distance of the voxel. Optionally, the method includes correcting for apparent axial shifts of the apparent position of a voxel.

As used herein, the words “comprise”, “include”, and “having”, or variations such as “comprises”, “comprising”, “includes”, and “including”, are used in an inclusive sense, i.e. to specify the presence of the stated features but not to preclude the presence or addition of further features in various embodiments of the invention.

### BRIEF DESCRIPTION OF THE DRAWINGS

One or more embodiments of the present invention will hereinafter be described with reference to the accompanying figures, in which:

FIG. 1 is a schematic diagram of an exemplary system for generating volumetric images of an object space in a sample according to a preferred embodiment of the present invention;

FIG. 2 is a flowchart of a method for generating volumetric images of the object space in the sample according to another preferred embodiment of the present invention;

FIG. 3 is a flowchart of a step of processing signals referenced in FIG. 2;

FIG. 4 is a ray diagram of lightfield imaging under illumination at different oblique angles (α₁=0°, α₂=30°, α₃=60°);

FIG. 5 is a ray diagram illustrating mapping of excited voxels of an illumination slice at an angle α in object space to form lightfield images at a sensor plane;

FIG. 6 is a schematic diagram showing extraction of excited voxels from illumination of slices;

FIG. 7 is a view of the excited voxels as plane images rearranged in columns with respect to depth Z₁ to Z₄ and re-assigned into stacks according to depth;

FIG. 8a shows lightfield images captured of a sub-resolution fluorescence sample under lightsheet illumination at different angles;

FIGS. 8b and 8c are plots of the Transverse (XY) and axial (XZ) PSFimaging retrieved from lightfield images of FIG. 8a using conventional lightfield depth retrieval tools;

FIG. 9a shows plots of XY, XZ, and YZ slices of a 1 μm fluorescent microsphere excited by scanned lightsheet illumination at 60° retrieved by conventional lightfield depth retrieval tools (left-hand column) and the method according to preferred embodiments of the present invention (right-hand column);

FIG. 9b are bar plots of XZ and YZ axial FWHM profiles of the 1 μm fluorescent microsphere of the conventional lightfield depth retrieval tools (left bar plots) and as retrieved by the method according to preferred embodiments of the present invention (right bar plots);

FIG. 10a is a schematic diagram demonstrating imaging of lithographic microstructure for validation purposes;

FIG. 10b are plots of XY slices containing letters “A” and “U” at z=−2 μm and z=2 μm retrieved by conventional lightfield depth retrieval tools (left-hand column) and the method according to preferred embodiments of the present invention (right-hand column);

FIG. 11a are plots of YZ slices across the centre of the microstructure retrieved by conventional lightfield depth retrieval tools (left-hand column) according to preferred embodiments of the present invention (right-hand column);

FIG. 11b shows normalized axial intensity profiles across letter “A” retrieved by conventional lightfield depth retrieval tools (left-hand column) according to preferred embodiments of the present invention (right-hand column);

FIG. 12a shows optical path change of light induced by refractive index change in sample and the resulted axial focal shifts of modelled voxels can be compensated by iterative methods; and

FIG. 12b shows multi-view excitation and axial reassignment.

### DESCRIPTION OF EMBODIMENTS

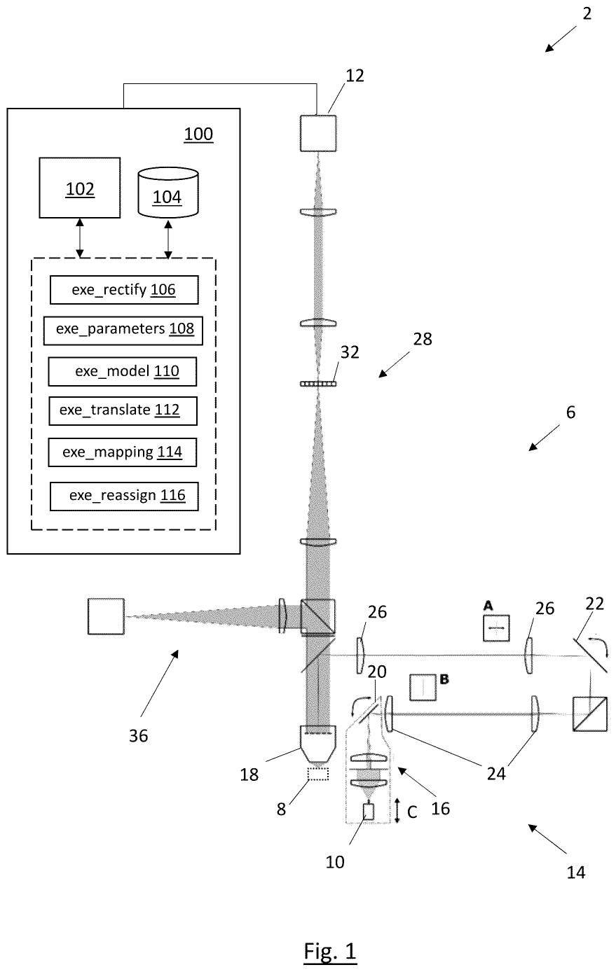

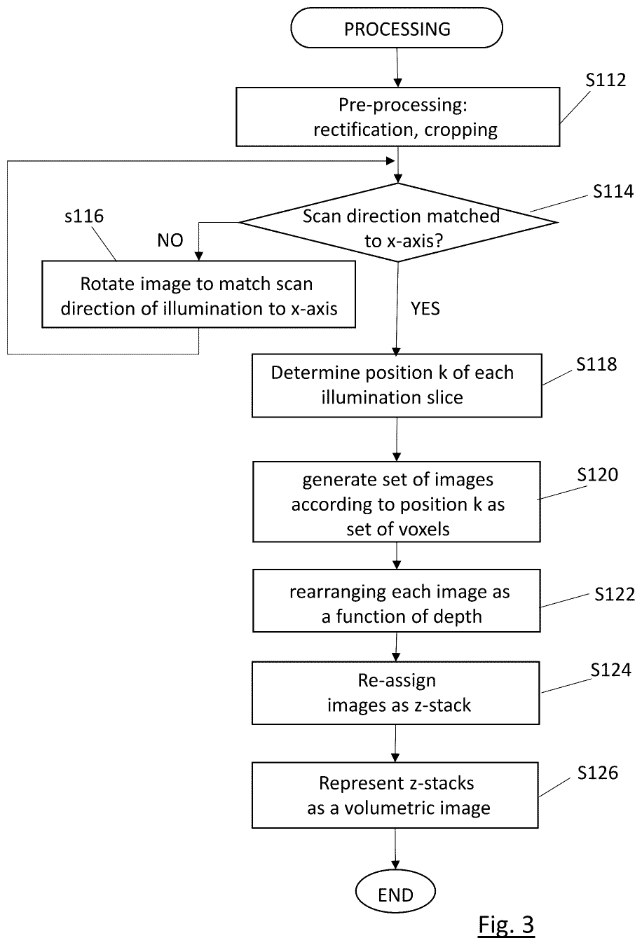

Referring now to FIGS. 1 to 12b, there are described lightsheet microscopy systems 2 and methods 4 for volumetric imaging of an object space 8 according to preferred embodiments of the present invention. The systems 2 and methods 4 are suitable for volumetric imaging of a sample (not shown) located with the object space 8.

The lightsheet microscopy system 2 has an apparatus 6 for guiding excitation light from a laser light source 10 to illuminate the object space 8 of the sample and which then guides the light to a detector 12, as illustrated in FIG. 1. The system 2 also has a computing environment 100 for processing signals from the detector 12, which is described in more detail in the following paragraphs. The apparatus 6 also includes scanning apparatus 14 which forms the excitation light into a sheet of light (i.e. the excitation light is formed into a plane and projected into the object space 8), otherwise known as a ‘lightsheet’, from the laser light source 4. In the embodiment shown in FIG. 1, the scanning apparatus 14 includes a collimator, iris and lens 16, all mounted on a single axis translation stage (not shown) which collimates, crops and focuses the light. In an example, the scanning apparatus 14 is configured to form the lightsheet with a thickness of about 2.4 μm.

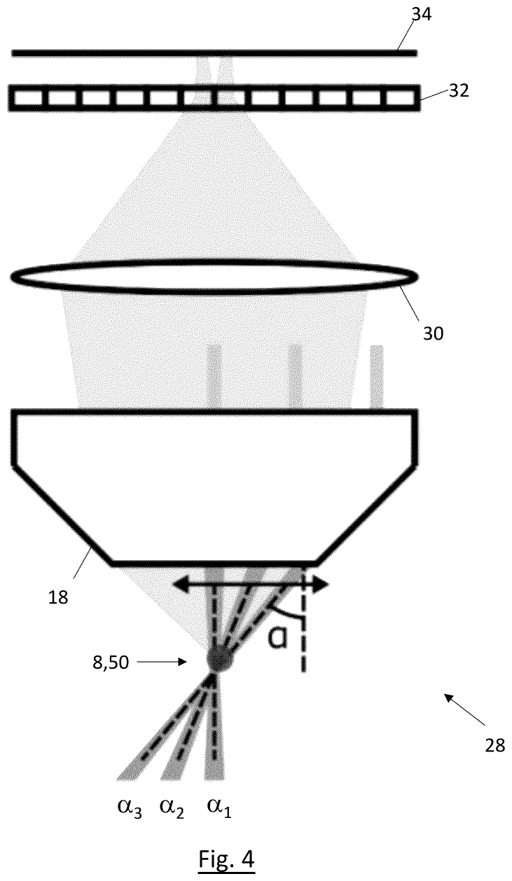

The scanning apparatus 14 guides the lightsheet to a back focal plane of an objective lens 18 for illumination of the object space 8. Referring to FIG. 4, the angle of incidence α of the lightsheet is shown, being the angle at which it enters the object space 8 with respect to an optical axis of the objective lens 18. The angle of incidence α is adjustable by means of translating the stage on which the laser, collimator, iris, and lens 16 are located, where translation of the stage is in the direction of double-head arrow ‘C’ in FIG. 1. The translation of the stage effectively offsets the lightsheet at the back focal plane of the objective lens 18. The resulting angle of incidence α is conveniently referred to herein as illumination angle α, which can be adjustable as illustrated in FIG. 4. In this arrangement, a maximum illumination angle α of about 60° is achieved with a 1.3 NA objective lens however it can be understood that greater or lesser illumination angles α can be provided depending on the design, requirements and limitations of the system 2.

The scanning apparatus 14 comprises a pair of scanning galvo mirrors 20, 22 and associated lenses 24, 26. One scanning galvo mirror 20 scans the beam of light vertically at a much higher frequency than the detector rate, thereby forming a thin time-averaged beam which forms the lightsheet. The boxes labelled B and A in FIG. 1 show the profile of the light beam after the scanning galvo mirrors 20 and 22 respectively.

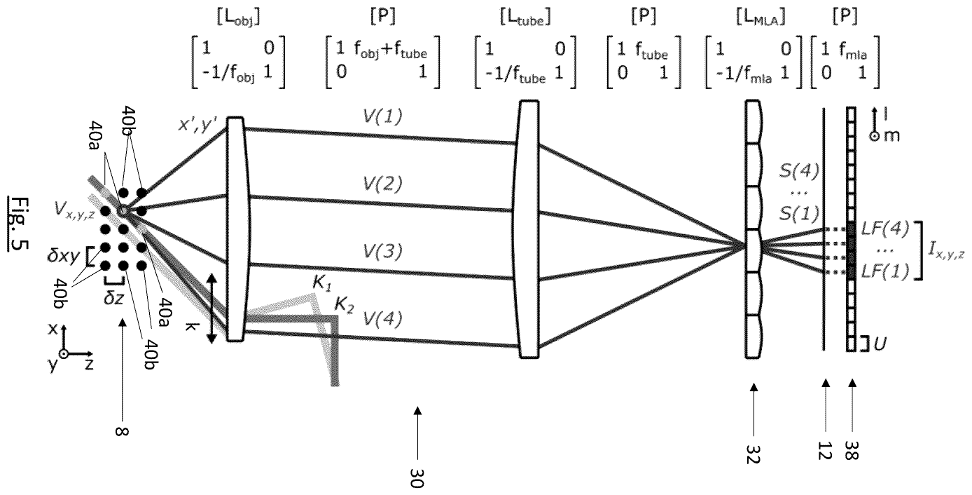

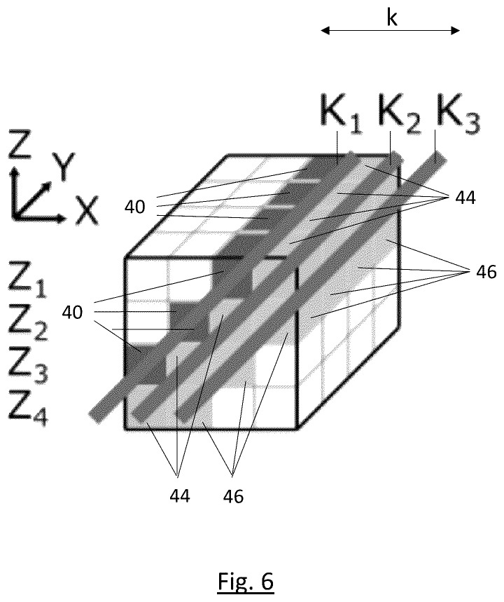

The second scanning galvo mirror 22 scans the laser line horizontally to achieve scanning plane illumination to translate the lightsheet laterally across the object space 8. As described herein, the object space 8 is imaged (by detector 12) when illuminated by the lightsheet at different positions and optionally different illumination angles α such that each image is essentially associated with the lightsheet effectively stationary at a particular position (and optional illumination angle α)—such a “stationary” lightsheet is referred to herein as an illumination slice K. An index can be used to distinguish between different illumination slices K, such as differentiating between illumination slices K₁, K₂, and K₃ in FIG. 6. Optionally, the lens 16 comprises an electronically tuneable lens (ETL), thereby enabling control over the focal point of the laser line. Advantageously, use of a lens 16 comprising an ETL may improve the effectiveness of the lightsheet illumination by enabling adjustment to ensure that the focal point is optimally positioned within the object space 8.

In the implementations described herein, “k” (for example, as shown in FIG. 5 and FIG. 6) is the lateral translation of the lightsheet with respect to the optical axis of the objective lens 18, for example, translation along the x-axis lateral to the optical axis defined as a z-axis. In the examples of FIG. 5 and FIG. 6, each of K₁, K₂, and K₃ is at different positions along the x-axis.

The apparatus 6 also includes a lightfield detection apparatus 28 which includes the objective lens 18 and a tube lens 30 for effective magnification of 111× at the image plane 34 of the detector 12. The detection apparatus 28 also includes a microlens array 32, which in an example has a pitch and focal length of 150 μm and 3700 μm respectively. In a preferred embodiment, the apparatus for lightfield detection 28 is arranged with unfocused lightfield detection where the microlens array 32 is placed at an image plane 34. In a more preferred embodiment, the microlens array 32 is placed at an image plane 34 of a standard epi-fluorescence microscope.

The detected light (for example, from the fluorescence emitted by a sample, located within the object space 8, when illuminated by an illumination slice K projected into the object space 8) is divided into a plurality of partial lenslet images by the microlens array 32. The microlens array 32 thereby enables lightfield images to be capture of the object space 8; lightfield images comprise both intensity information and information regarding the direction that the light rays incident on the detector 12 are traveling. In a preferred embodiment, the system 2 includes that each microlens is underfilled by having an imaging-side NA smaller than the NA of the microlens array 32 (focal length-3700 μm, aperture size-150 μm, NA-0.02)) which advantageously ensures lightfield imaging without overlapping lenslet images.

For the purposes of this disclosure, the “x-axis” and “y-axis” are taken to be those parallel the plane of the detector 12 (i.e. parallel the image plane 34) and the “z-axis” is taken to be that perpendicular to the detector 12 and image plane 34. Therefore, the x-axis and γ-axis correspond to the spatial resolution of the detector 12 (“transverse” resolution) whereas the z-axis corresponds to the depth of the object space 8 (“axial” resolution).

The apparatus 6, as illustrated in FIG. 1, also has an optional conventional widefield detection apparatus 36 however this is for the purposes of comparing the method and system of the embodiments of the present invention with conventional lightfield detection as discussed in more detail below in the section entitled ‘Validation’.

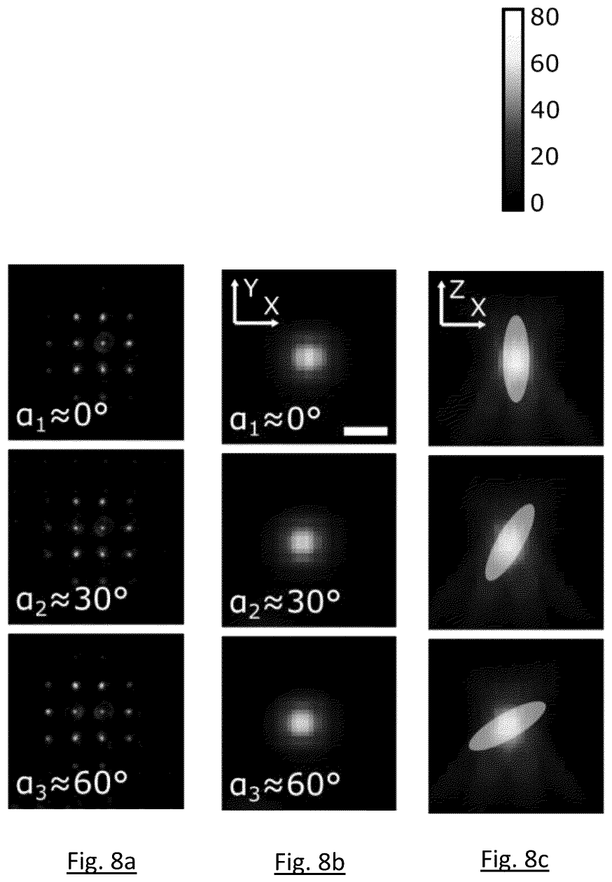

To illustrate the drawbacks of the conventional lightfield depth retrieval techniques, FIG. 8a shows three lightfield images captured when illuminating a single 1 μm fluorescence microsphere 50 at three corresponding illumination angles (α₁=0°, α₂=30°, α₃=60°). Using existing standard lightfield depth retrieval tools, a Point Spread Function (PSF) can be calculated from each of the lightfield images of FIG. 8a.

FIG. 8b shows Transverse (XY) and FIG. 8c shows Axial (XZ) PSFs retrieved from the three distinct illumination conditions of FIG. 8a. The results for both the Transverse (XY) PSFs (when compared to one another) and Axial (XZ) PSFs (when compared to one another) at the different illumination angles α₁, α₂, α₃. are almost identical. FIG. 8c also shows overlaid the calculated Axial PSFs (PSF_{imaging}) for each illumination angle α1, α₂, α₃. calculated according to:

PSF_{imaging}=ObliquePSFᵢₗₗᵤₘᵢₙₐₜᵢₒₙ×PSF_{detection} (Eq. 1)

This equation is based on the observation that the imaged Point Spread Function (PSF_{imaging}) from illumination with an oblique beam can be derived from multiplying the lightsheet PSF (ObliquePSFᵢₗₗᵤₘᵢₙₐₜᵢₒₙ) with the Point Spread Function of the detector (PSF_{detection}).

Based on the three different illumination angles illumination angles α₁, α₂, α₃, the retrieved Axial PSF_{imaging}, in FIG. 8c, should present a skewed intensity profile (ellipses). Because lightfield detection results in a lower spatial resolution at the detector 12 compared to the diffraction-limit resolution of the objective lens 18 (e.g. due to the diameters of the microlenses), the Inventors anticipate that the PSF_{detection} has a wider spatial extent than a confined ObliquePSFᵢₗₗᵤₘᵢₙₐₜᵢₒₙ of thin thickness. This means ObliquePSFᵢₗₗᵤₘᵢₙₐₜᵢₒₙ can result in significant spatial modulation over PSF_{imaging} in the axial direction (via Eq. 1). An incorrect PSF_{imaging} therefore results in inaccuracy in depth retrieval and results in poor Richardson-Lucy deconvolution.

The Inventors have determined that it is desirable to restore PSF_{imaging} by use of the preferred embodiments of the present invention as described more fully in the following paragraphs.

The lightfield detection apparatus 28, according to embodiments of the present invention, utilises a collection of lightfield images captured of object space 8 when illuminated by illumination slices K from different positions and/or directions. Unless stated otherwise, it is assumed herein that each lightfield image is uniquely associated with a position of incidence at a common (to all lightfield images 38) illumination angle α.

Referring to FIG. 6, the object space 8 is divided into a plurality of 3D imaging units, herein referred to as “voxels 40”. Each voxel 40 represents a 3D-position within the object space 8. The voxels 40 are sized such that each can be independently measured by the lightfield detection apparatus 28 (i.e. the voxels 40 should have dimensional lengths greater than the resolving capability of the lightfield detection apparatus 28). The voxels 40 in FIG. 6 are shown as cubes however this is not intended to be limiting—for example, voxels 40 may instead represent spatial coordinates separated by sufficient distances to minimise or eliminate overlap in signal detection between adjacent voxels 40, as represented in FIG. 5.

For ease of description, the term “voxel 40” is used to represent a corresponding location in the “real” object space 8 as well as the corresponding element of a resulting volumetric image (i.e. a data structure) of the object space 8.

With reference to FIG. 5, there is shown a schematic diagram showing how the voxels 40 of the object space 8 relate to the lightfield images 38. In the figure, two separate lightsheets K₁ and K₂ are shown illuminating the object space 8. As shown, the first lightsheet K₁ is incident from a different position to the second lightsheet K₂ (but at the same illumination angle α. The figure shows certain voxels 40a as being illuminated by the second lightsheet K₂ whereas the remaining voxels 40b are not illuminated.

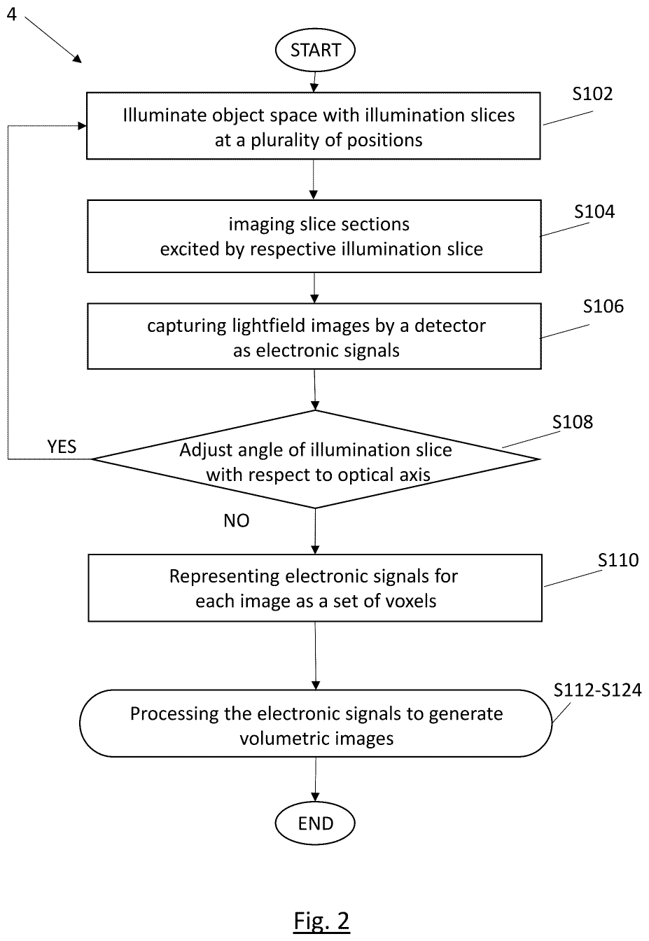

According to an embodiment, each illumination slice Kᵢ is associated with a particular translation of the lightsheet with respect to the x-axis direction. In the embodiment shown, the illumination slices Kᵢ are spaced by distance k along the x-axis. Essentially, in the embodiment shown, the lightsheet K is scanned horizontally (i.e. along the x-axis) across the object space 8, in the first step (S102) of method 4 as exemplified in FIG. 2. The choice of aligning the direction of translation of the lightsheet with the x-axis is arbitrary, but may simplify calculations. In such an arrangement, the other transverse axis (y-axis) is parallel to the plane of the lightsheet.

By use of a ray transfer matrix (described in more detail below), the intensity of each voxel 40 (that is, an emission of a sample from the position in object space 8 associated with the voxel 40) can be determined from the detected lightfield image obtained when the particular voxel 40 was illuminated. Considering the example of FIG. 5, the captured lightfield image associated with illumination slice K₂. is suitable for determining an emitted intensity for each illuminated voxel 40a.

Each voxel 40 is assumed to have an associated emitted intensity I_{x,y,z}. In this example, the schematic diagram of FIG. 6 shows three illumination slices K₁, K₂ and K₃, each at the same illumination angle α, exciting diagonally arranged voxels 40a, 40b, 40c of different portions of the object space 8. That is, the use of angled illumination slices K allows for different depths of the object space 8 to be imaged in each lightfield image, as the different depths are separated in the transverse plane.

Thus, in step S108, the detector 12 images a sample illuminated by a plurality of illumination slices K projected into the object space 8 (step S104 of FIG. 2) by the detector 12, thereby creating a corresponding plurality of lightfield images (such that each lightfield image is associated with a unique one of the illumination slices K). In an embodiment, during steps S102 to S108, the lightsheet is scanned horizontally (i.e. in the direction k of FIG. 5 and FIG. 6) at a constant angle α. The resulting plurality of illumination slices K are parallel to each other as illustrated in FIG. 5 and FIG. 6. Additionally, in an embodiment, the illumination slices K correspond to constantly spaced steps of the lightsheet along the x-axis (e.g. with spacing δx). Generally, sufficient lightfield images are captured to ensure every voxel 40 is illuminated by an illumination slice K.

In an embodiment, the oblique angle α is varied (step S108). Steps S102 to S106 can then be repeated, to capture lightfield images as electronic signals by scanning the object space 8 at multiple illumination angles α as well as multiple illumination positions. In such a case, each illumination slice K and each lightfield image can be associated with (for example, indexed by) both a position of incidence and an angle of incidence α of the lightsheet.

In the steps S112 to S124, once sufficient lightfield images have been captured, the computing system 100 can process the lightfield images to generate a volumetric image. The computing system 100 can include a processor 102 and a data storage 104 (e.g. a volatile and/or non-volatile memory such as one or more hard drives, optical drives, dynamic memories, or solid-state memories) which can store the lightfield images collected by the detector 12, and other information, including system parameters, associated with the system 2. The detector 12 is in data communication with the computing environment 100 and the processor 102 is configured to carry out instructions in the form of software library routines or modules 106 to 114 which are written specifically to process the electronic signals in accordance with the embodiments of the invention and with reference to FIG. 1.

FIG. 5 illustrates schematically the physical basis for the computational model implanted by steps S112 to S124, according to an embodiment. The figure illustrates the relationship between the intensity of light emitted by a sample at the location of a particular voxel 40a to the resulting detected signal at the detector 12. For the purposes of illustration, four light rays R(1)~R(4) are traced from the location of the particular voxel 40a in the object space 8 to coordinates S(1)~S(4) on the detector 12. The light rays R(1)~R(4) are then (effectively) mapped to pixels LF(1)~LF(4) of a lightfield image (i.e. a 2D array of detector pixels associated with a particular microlens which is itself associated with a particular voxel 40 in a particular lightfield image). The resulting lightfield pixel is analysed in order to retrieve a measurement of an intensity of light emitted by the sample at the location of the particular voxel 40a.

According to this embodiment, the computational model uses ray transfer matrix analysis, where individual rays R(N) of a voxel 40 are mapped from the object space 8 to the sensor plane S as shown in the equation below,

S_{x″,y″}(N)=[P][L_{MLA}][P][L_{tube}][P][L_{obj}]V_{x,y,z,′,y′}(N) (Eq. 2)

where the voxel's spatial coordinates are (x, y, z), ray index is defined by N, a ray's coordinates along the aperture of the objective lens are given by (x′, y′), a ray's coordinates on the sensor plane are (x″, y″), the free space transfer term is [P], and the thin lens transfer terms for the objective lens, tube lens, and the microlens array are defined as [L_{obj}], [L_{tube}], and [L_{MLA}], respectively. V is formed by discrete sampling of the object space using lateral and axial sampling factors δ_{xy} and δ₂. By indexing each unique ray with N, S(N) represents the lateral coordinates of the ray R(N) on the sensor plane 12 (with respect to a microlens). The above equation also includes the encoding of angular information in lightfield imaging.

Although FIG. 5 shows the propagation of rays R(N) with respect to the XZ-plane, generally, the propagation of rays R(N) in both the XZ-plane and YZ-plane are determined; the results can then be combined to express a particular ray's 2D divergence angle from the optical axis. By evenly distributing N rays R(N), angular information of the signal (e.g. fluorescence) emitted by a voxel 40 can be calculated.

Considering the indexing of the voxels 40, the focal point of the objective lens 18 can be taken as the origin of the volumetric image defined by the set of voxels 40. It can be preferred to use a regular spacing of voxels V_{x,y,z}, for example, by using transverse and axial sampling factors δxy and δz (respectively). That is, the “size” of each voxel 40 in relation to the object space 8 is the product δxy×δz.

Next, we determine the expected lightfield image. The equation below describes how the sensor plane S is mapped to the lightfield pixel image LF,

LF_{l,m}(N)=S_{x,y}(N)/U (Eq. 3)

where the pixel size of the detector 12 is U, and lightfield image pixel coordinates are (l, m). For illustration purpose, FIG. 4 shows four light rays R(1)~R(4) that are focused through a particular microlens of the microlens array 32 onto the detector 12 at S(1)~S(4) and recorded as LF(1)~LF(4). Since the detector 12 samples an image discretely, bilinear interpolation is applied at this step to construct each voxel intensities. The detected intensity I is the summation and averaging of all rays R(1)~R(4).

The equation below is used to calculate the expected intensity Ixyz of the respective voxel 40 (i.e. the voxel 40 located in the object space 8 at coordinates (x, y, z)),

$${I}_{x , y , z} = \frac{1}{N} {\sum }_{1}^{N} {LF}_{l , m} ( N ) \qquad ( Eq . 4 )$$

FIG. 6 shows how mapping of an illumination slice K at an angle α in object space 8 forms a volumetric image. In effect, once an intensity I_{x,y,z} is calculated for each voxel 40, it is possible to construct the volumetric image simply by assigning each voxel 40 to its location in the object space 8. Therefore, although a single lightfield image is associated with voxels 40 at different depths for different x-axis positions, the result of processing the set of all lightfield images is a data structure suitable for 3D volumetric imaging.

The reassignment process is given by the equation below,

Z_{z}=P_{k(z)} (Eq. 5)

where P_{k(z)} is the set of lightfield images, and Z_{z} is the slice at depth z. Both OP images and Z-slices have pixel coordinates i,. (z) is described below which is used to locate the OP image with index k where pixel i,j is to be extracted from.

Optionally, the model can consider the thickness of the oblique plane illumination t during processing. This involves summing over a given voxel's nearby voxels along z axis (and itself) to represent a combined intensity, described in the equation below, where the resultant voxel intensity is I′, and D=t/δz is the “depth factor” (i.e. D represents the proximate number of voxels covered by the thickness of the oblique plane). By considering t, fluorescence signal collection is maximized while removing out-of-focus light.

$${I}_{x , y , z} = {\sum }_{- D / 2}^{D / 2} {I}_{x , y , z + D δ z} \qquad ( Eq . 8 )$$

That is, the summed intensity I′ is based on the in-focus intensity I for the voxel in question (i.e. V_{x,y,z}) and the in-focus intensity for each adjacent voxel in the z-direction (within the distance (±D/2)).

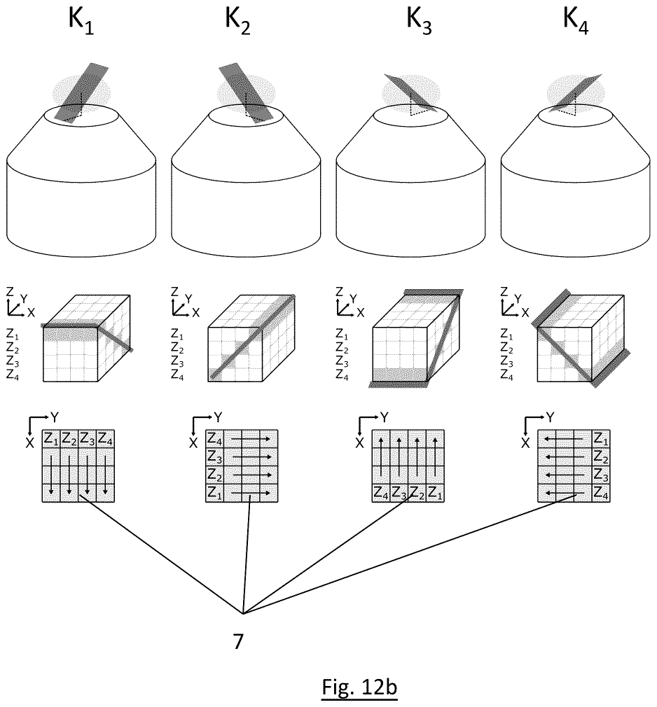

Referring to FIG. 12a, a sample 60 can itself introduce a deviation between the apparent point of illumination 62 within the sample 60 and the actual point of illumination 64, due to refractive index effects of the sample 60. For example, refractive index effects of a sample 60 can result in an optical path change which can lead to axial (z-direction) focal shifts. This can result in the relative positions of modelled voxels 40 deviating from the corresponding relative positions within the sample 60, which may result in the modelled voxels 60 representing an aberration with respect to the sample. This is shown by 66 (illuminated position) and 68 (apparent point of emitted light from sample 60)

Therefore, in an embodiment, Eq. 8 is utilised in order to identify, quantify, and assess axial focal shifts. The embodiment is based on the known position of the particular illumination slice K from which an expected position 64 of an excited voxel can be identified; an axial focal shift is expected to cause the apparent (i.e. modelled) position 62 of the excited voxel 40 to be shifted with respect to the expected position 64 in the axial direction (z-direction). Therefore, in this embodiment, Eq. 8 is utilised as a search function over a range of voxels 40 in the axial direction with respect to the expected position of the voxel 40. The search function looks to maximise

$${I}_{x , y , z}^{′}$$

with respect to z. The apparent maximum intensity can then be mapped to the excited voxel 40; thereby accounting for focal shift.

Then, by tuning the parameters in Eq. 2 according to this procedure and therefore using the correct coordinates, axial reassignment by depth mapping can produced a lightfield image which advantageously has reduced or no aberration for the given illumination slice K.

This embodiment can optionally be extended by using multi-view excitation, as shown in FIG. 12b; that is, by illuminating the same voxel 40 with illumination slices K rotated about the z-axis (see K₁, K₂, K₃, K₄ representing rotations in 90° increments, although other angular steps can be utilised). This may advantageously allow iterative determination of axial focal shifts among the full aperture.

### Example Implementation Using MATLAB

Several MATLAB™ modules may be suitable for implementing steps of the method 4. In particular, the Inventors have made use of the following MATLAB modules: EXE_rectify 106; EXE_parameter 108; EXE_model; EXE_translate 110; EXE_mapping 112; and EXE_reassign 114, and their functionalities are set out in Table 1 below. These modules may be suitable for performing aspects of steps S112 to S126. Although the modules 106 to 114, with the functionalities set out in the table below, are prepared as MATLAB modules, this is not intended to be limiting as the functionality of one or more of said modules can be implemented via different programming language or modules, as would be known by a person skilled in the art

TABLE 1
MATLAB package modules

| | |
|---|---|
| EXE_rectify | EXE_rectify performs lightfield image preprocessing |
| EXE_parameter | EXE_parameter outlines the parameters used in FOR modelling. |
| | Alternatively, if a pre- computed FOR model is available, |
| | EXE_parameter outlines the parameters of the pre- computed |
| | model. |
| EXE_model | EXE_model performs FOR modelling using parameters defined |
| | in EXE_parameter. If a pre-computed model is to be read, |
| | EXE_model extracts datasets from the pre-computed model for |
| | depth mapping. |
| EXE_translate | EXE_translate determines lateral translation as a function of scan |
| | index. |
| EXE_mapping | EXE_mapping performs depth mapping. Oblique angle is |
| | defined in EXE_mapping. EXE_mapping reads indexed |
| | lightfield images and their lateral translation and generate a set of |
| | oblique plane images with a given oblique angle. |
| EXE_reassign | EXE_reassign performs reassignment on a set of oblique plane |
| | planes to form a z-stack. |

In module EXE_rectify 106, lightfield image processing is performed to ensure that the lateral translation is interpreted correctly in subsequent modules EXE_mapping 114 and EXE_reassign 116. To do this, the lightfield images must be rotated so that the illumination angle α, i.e. the scanning direction, is matched to the x-axis of the model used (see steps S114 to S116). Therefore, the depth information can be retrieved from the lightfield images by the present method 4 at any oblique angle α.

Module EXE_recify 106 involves lightfield image pre-processing in step S112 which can include a lightfield image rectification or calibration step. In one embodiment, the rectification comprises capturing an image of sample with uniform fluorescence emission, for example, a fluorescence microscope slide. The lightfield image of the uniform fluorescence emission is used to generate microlens array rectification settings based on the specific lightfield detection optics used. The Inventors have found adjusting the oblique angle α has no appreciable effect on the rectification settings.

Module EXE_recify 106 can involve further pre-processing which includes cropping the raw lightfield images to be scaled to have an integer N number of pixels as only lightfield images with a field of view (FOV) of smaller than a modelled FOV are acceptable.

Module EXE_parameter 108 outlines the parameters used in the determination of the volumetric images which are calculated in the subsequent modules EXE_model 110, EXE_mapping 114 and EXE_reassign 116.

Module EXE_model 110 performs modelling using the parameters defined in module EXE_parameter 108. To assist in faster calculation, pre-calculations based on previously known parameters from a known system can be made by extracting datasets from a pre-computed model. The parameters for the pre-computed model can be outlined in module EXE_parameter 108. The following table sets out the parameters used in module EXE_model 110.

TABLE 2
Parameters involved in EXE_model

| | |
|---|---|
| N | Ray density N |
| fov_xy | Field of view (μm) of the object space to be modelled |
| fov_z | Depth of the object space to be modelled |
| res_xy | Lateral sampling (μm) |
| res_z | Axial sampling δxy (μm) |
| obj_f | Focal length of the objective lenses fobj (μm) |
| obj_na | Numerical aperture of the objective lenses |
| tube_f | Focal length of the tube lenses ftube (μm) |
| mla_pitch | Pitch size (μm) of the MLA lenslet |
| mla_f | Focal length of the MLA fMLA (μm) |
| pixel_size | Pixel size U (μm) of imaging sensor |

As the illumination slices K are translated laterally, k, from each other a series of lightfield images are recorded, where each lightfield image represents illumination at a unique k assigned to a scan index. To determine the position k of each illumination slice K at step S118, a calibration protocol is performed to determine lateral translation k as a function of scan index in module EXE_translate 112. The calibration involves ensuring that the galvo mirror 20 is conjugated to the back focal plane of the objective lens so that tilt-invariant scan can be achieved and that the microlens array 32 is conjugated to the front focal plane of the objective lens 18. Once the correct conjugations are achieved, lateral translation can be determined by imaging a sample with uniform fluorescence emission and plotting processed lightfield images to determine the illumination profiles with their spatial position and which advantageously ensures accuracy of k.

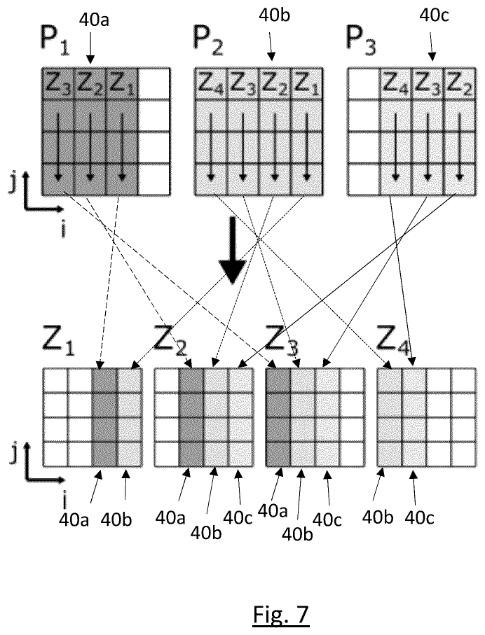

The emission intensities of each of voxel 40 when excited by respective illumination slices K, are then mathematically re-assigned back into the 3D positions (see step S124) using different Z-slices. In the example shown in FIG. 7, Z-slices Z₁, Z₂, Z₃, Z₄ are mapped to the depth of the illumination slices K₁, K₂ and K₃. Depth mapping is facilitated by EXE_mapping 114 and can be done on either single lightfield images, a sequence of indexed lightfield images, or lightfield images live streamed from an imaging sensor/detector 12.

In module EXE_mapping 114, the lightfield images are received along with its lateral translation which was determined in EXE_translate 112 to generate a set of images according to position k as a set of voxels (step S120). This generates a set of oblique plane images P₁, P₂ and P₃ for a given illumination angle α. Then each plane image P₁, P₂ and P₃ can be rearranged to have voxels 40, in the form of columns of pixels, (voxels) which relate to one or more of the different depths Z₁, Z₂, Z₃, Z₄ (see FIG. 6 and FIG. 7) which is termed so called ‘depth mapping’.

These columns of voxels 40 are then re-assigned to different plots or z-stacks, each of which relate to the different depths in step S124 in module EXE_reassign 116. In particular, the column of pixels (voxels) in image P₁ relating to depth Z₃ is assigned to Z₃ stack, the column of pixels in image P₁ relating to depth Z₂ is assigned to Z₂ stack, and the column of pixels in image P₁ relating to depth Z₁ is assigned to the Z₁ stack (see dashed lines in FIG. 7). Similarly, the column of pixels or voxels 44, 46 in P₂ and P₃ are re-assigned to corresponding z-stacks Z₁, Z₂, Z₃, Z₄ (see dotted and solid lines). Computationally, the re-assignment of the pixels represents only 5% of the computation required and therefore can be this step can be computed rapidly. The different z-stacks are then represented graphically to provide a volumetric image as desired in step S126 by a graphics module.

Therefore, by the system 2 and method 4 of this preferred embodiment of the present invention, more accurate information on the depth of the sectioning of the object space 8 is achieved than was previously possible by standard depth retrieval techniques.

In addition to obtaining improved depth information from the detected lightfield images, in this method and system of the present invention, the depth information can be advantageously retrieved regardless of the lightsheet angle α. Specifically, the S_{x″,y″} dataset does not rely on the angle of oblique plane illumination a because it models all voxels 40 sampled in the object space 8, while mapping an illumination slice K only involves a subset of the voxels 40. This means that illumination of any angle α can be mapped by S_{x″,y″}, which can be pre-computed using the system parameters that have been predetermined, for example using module EXE_parameter 108.

The Inventors have found that the performance (i.e. computational efficiency) of depth identification step depends heavily on both the size of S_{x″,y″} dataset and oblique angle α of the illumination slices K. Specifically, a large angle α results in more voxels 40 in the x axis to be interrogated by the equation below which describes the profile of the oblique plane illumination slice hence increases time for depth mapping. Further, computational efficiency is associated with lateral sampling 8xy but the Inventors have found that the parameters of the objective lens, tube lens and microlens array have no significant influence on the computational efficiency.

Importantly, by the development of the system and methods disclosed, the Inventors have achieved recovery of depth information sufficient to generate fast high resolution volumetric images from single objective lightsheet microscopy with conventional microscopy imaging set-ups, preferably to generate volumetric images in real-time. Specifically, the depth information can be recovered without the need for the additional remote optical imaging unit typically required for conventional lightsheet microscopy. As discussed in the ‘Experimental Result: Validation’ section below, the optical sectioning is also advantageously improved by a factor of 2 and volumetric images can be achieved in about 0.5 seconds on a standard CPU without multicore parallel processing.

The Inventors consider this method 4 and system 2 to not only be useful for conventional laser scanning microscopes but applicable to a number of applications including adaptive optics and uses involving a structured beam (Airy beam).

Embodiments herein describe systems 2 and methods 4 which provide for 3D-imaging of an object space (more particularly, a sample located within the object space). For example, the sample may be a biological sample which, when illuminated by light of certain wavelengths may emit wavelengths at certain other wavelengths (e.g. via fluorescence).

The object space 8 is illuminated by a lightsheet (incident light defining a plane) and imaged by a lightfield detection apparatus 28 having an optical axis, such that the lightsheet is directed into the object space at an angle α with respect to the optical axis. The use of an oblique angle α and planar lightsheet enables the embodiments to effectively “see behind” front portions of the sample (i.e. those facing the lightfield detection apparatus 28), thereby enabling detection of light emissions at different depths of the sample.

The object space 8 can be associated with a set of voxels 40 and each voxel 40 can be illuminate by imaging the object space with lightsheets incident from different positions, such that the set of images thereby obtained represents, in total, each voxel 40 of the object space 8.

Lightfield techniques are therefore employed by embodiments herein described to enable accurate measurement of emitted light intensities by voxels 40 at all depths within the object space 8, and therefore, at all depths of the sample. In the embodiments herein described, a microlens array 32 is provided at the imaging plane of the lightfield detection apparatus 28 and a detector is arranged to detect the resulting images due to the microlens array 32. The lightfield images thereby obtained are suitable for reconstructing depth information to thereby enable accurate determination of the intensities emitted by each voxel 40, irrespective of voxel depth.

The embodiments herein described may advantageously allow for 3D-imaging of samples using oblique plane techniques, while enabling accurate reconstruction at different sample depths without the need for remote imaging units that may comprise two (or more) complementary objective lenses (secondary and tertiary objective lenses) in addition to a primary objective lens.

### Experimental Result: Validation

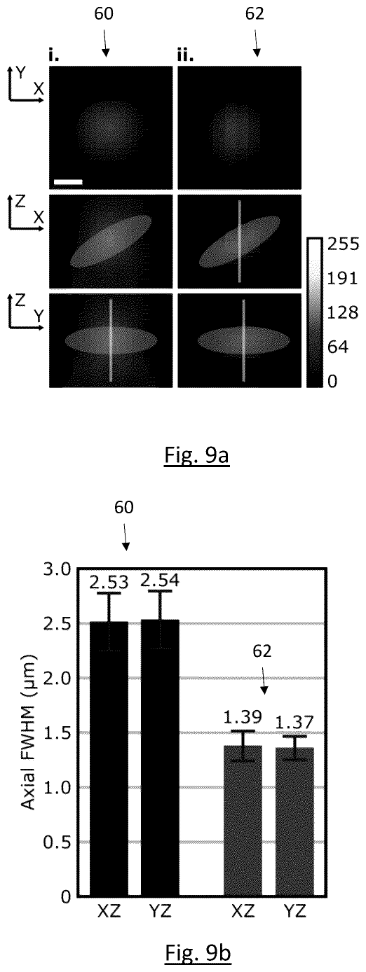

As a demonstration and validation of the more accurate volumetric imaging which is achieved by the method 4 and system 2 according to preferred embodiments of the present invention there is shown an example of imaging a 1 μm fluorescence microsphere 50 which is below the resolution limit of the optical system used as illustrated in FIG. 4. In FIG. 9a, the column shows imaging by standard lightfield depth retrieval techniques having significant out-of-focus blur in both XZ and YZ planes. The column of FIG. 9b shows imaging by the method and system as described above and demonstrates reduced out-of-focus signal by 2 folds in axial direction and showing effective PSF_{imaging} with axial FWHMs (1.39 μm and 1.37 μm) in XZ and YZ (see FIG. 9b) that are close to the theoretical limit of the system which is 1.35 μm with a profile almost identical to the ideal PSF_{imaging} and in doing so achieves accurate depth sectioning of the microsphere. Grey eclipses show the ideal PSF_{imaging}.

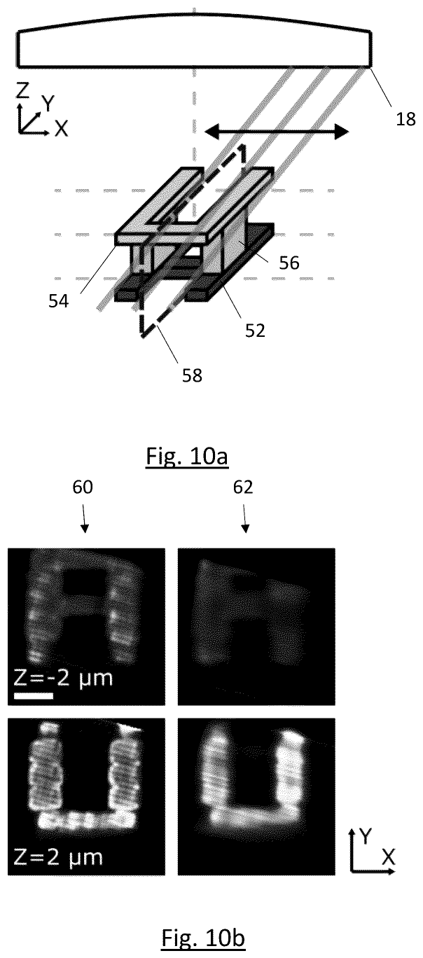

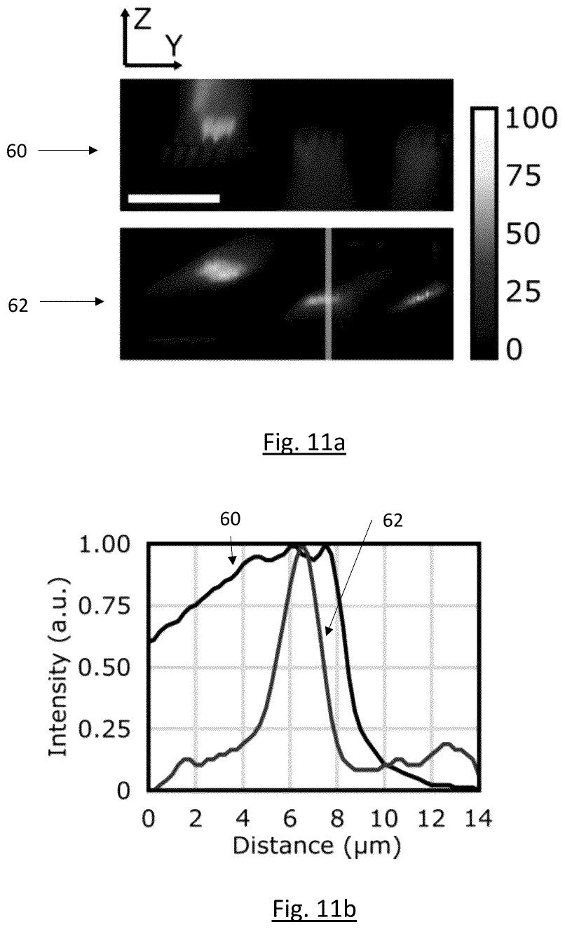

To further validate the present method and system on densely packed samples, imaging on customized laser-written rigid fluorescence microstructure, 52, 54, 56 was conducted, consists of letters “A” 52 and “U” 54 stacked vertically on a glass coverslip and by supporting structures 56 in the example illustrated in FIG. 10a. The solid lines represent scanned illumination slices K while dashed lines represent the YZ slice across the centre of the microstructure 52, 54, 56. FIG. 10b shows XY slices containing letters “A” and “U” at z=−2 μm and z=2 μm, respectively by standard light depth retrieval techniques in the left-hand column and with the imaging techniques of the present method and system in the right-hand column. This gives a small separation of 4 μm along the z axis between “A” and “U” to test axial sectioning.

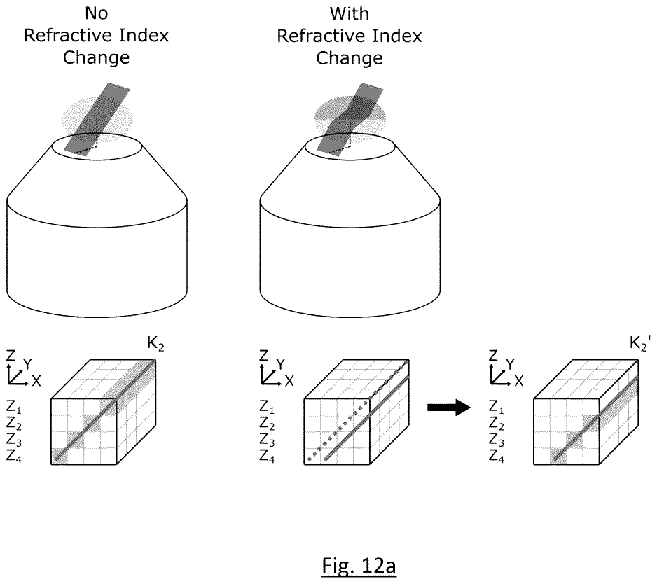

From FIG. 10b, both the standard lightfield depth retrieval techniques and the imaging techniques of the present method and system appear to show the letters at their designated axial position accurately, excluding any out-of-focus intensity arisen from the other letter located 4 μm away in z. However, upon closer examination on the YZ slice (see FIG. 10b) across the centre of the microstructure (dashed lines in FIG. 10a), we observed that the standard lightfield depth retrieval techniques (item 60—left-hand column of FIG. 10b) only eliminated half of the out-of-focus cones, while imaging method of the present invention, (item 62—right-hand column of FIG. 10b) shows no out-of-focus cones. FIG. 11a plots the normalized axial intensity across letter “A” (white lines in FIG. 11a) and quantifies the out-of-focus region where the top image is produced by standard lightfield depth retrieval techniques 58 while the bottom image 60 is produced by the method of the present invention. The standard lightfield depth retrieval technique results in an out-of-focus region extending over 8 μm (FWHM) in depth (see item 60). Conversely, the imaging with the method of the present invention achieves accurately mapped to z=−2 μm with an axial profile (FWHM) of 1.9 μm resulting in sharp axial fluorescence signal of letter “A” (see item 62 FIG. 11b). The results of the present imaging method and system on densely packed fluorescence microstructures shows significant improvement in depth sectioning over standard lightfield depth retrieval techniques.

Therefore, the system and method for generating volumetric images described above advantageously provides more accurate and greater depth information with sufficiently fast computation so as to generate volumetric images in real-time in standard laser scanning microscopes without the need for a remote optical imaging unit.

Further modifications can be made without departing from the spirit and scope of the specification.

### REFERENCES

[1] Bouchard, Matthew B., et al. “Swept confocally-aligned planar excitation (SCAPE) microscopy for high-speed volumetric imaging of behaving organisms.” Nature photonics 9.2 (2015): 113-119.
   https://doi.org/10.1038/nphoton.2014.323
[2] Kumar, Manish, et al. “Integrated one- and two-photon scanned oblique plane illumination (SOPi) microscopy for rapid volumetric imaging.” Optics express 26.10 (2018): 13027-13041.
   https://doi.org/10.1364/OE.26.013027
[3] Madaan, Sara, et al. “Single-objective selective-volume illumination microscopy enables high-contrast light-field imaging.” Optics Letters 46.12 (2021): 2860-2863.
   https://doi.org/10.1364/OL.413849 [4] Yang, Bin, et al. “DaXi-high-resolution, large imaging volume and multi-view single-objective light-sheet microscopy.” Nature methods 19.4 (2022): 461-469.
   https://doi.org/10.1038/s41592-022-01417-2

1. A microscopy method for volumetric imaging of a sample located within an object space, comprising:
obtaining a set of lightfield images using a lightfield detection apparatus, each associated with an illumination slice corresponding to a lightsheet projected into the object space from a particular illumination position and at an illumination angle non-parallel to an optical axis of the lightfield detection apparatus, such that each voxel of a set of voxels associated with the object space is illuminated by at least one illumination slice, wherein each voxel is defined by a position in the object space; and
determining, for each voxel, an intensity of light emitted from the object space associated with said voxel using, in part, angular information captured by the lightfield images,
such that the determined intensities for each voxel of the set of voxels defines a volumetric image of emitted light intensity within the object space.

2. The method according to claim 1, further comprising:
scanning a lightsheet at a plurality of positions to illuminate the object space, such that each position is associated with an illumination slice corresponding to the lightsheet; and
imaging the object space when illuminated by each illumination slice to generate the set of voxels.

3. The method according to claim 1, wherein each voxel is associated with a depth in the object space being direction lateral to the optical axis.

4. The method according to claim 1, wherein the lightfield detection apparatus comprises a microlens array for generating the lightfield images.

5. The method according to claim 4 including positioning the microlens array at an image plane or wherein each microlens of the array has an imaging side NA which is less than the NA of the microlens array.

6. (canceled)

7. The method according to claim 2, wherein a scanning direction is a direction lateral to the angle of the plane of light.

8. The method according to claim 7, wherein the illumination positions are stepped at a constant step size when generating the set of lightfield images.

9. The method according to claim 1, wherein the illumination angle is adjustable such that each lightfield image is associated with a unique combination of illumination position and illumination angle.

10. The method according to claim 1, wherein determining the intensity of light emitted from the object space associated with said voxel includes summing adjacent intensities within a predefined axial distance of the voxel.

11. The method according to claim 1, including correcting for apparent axial shifts of the apparent position of a voxel.

12. A microscopy system for volumetric imaging of an object space of a sample, the system comprising a lightfield detection apparatus in communication with a computer having a processor and a memory:
the lightfield detection apparatus comprising optical elements being configured to:
scan a plane of light at a plurality of positions to thereby produce a plurality of illuminating slices, each associated with a unique position, wherein the plane of light formed from a laser light source at an illumination angle relative to an optical axis for illumination of the object space, such that each voxel of a set of voxels associated with the object space is illuminated by at least one illumination slice, wherein each voxel is defined by a position in the object space, and
image the object space for each illumination slice to thereby generate corresponding lightfield images for each illumination slice; and
the processor being adapted to execute a plurality of modules stored in the memory, each module being able to execute a set of instructions, wherein the modules are configured to:
determine, for each voxel, an intensity of light emitted from the object space associated with said voxel using, in part, angular information captured by the lightfield images,
such that the determined intensities for each voxel of the set of voxels defines a volumetric image of emitted light intensity within the object space.

13. The system according to claim 12, wherein each voxel is associated with a depth in the object space being a direction lateral to the optical axis.

14. The system according to claim 12, wherein the lightfield detection apparatus comprises a microlens array for generating the lightfield images.

15. The system according to claim 14, wherein the microlens array is positioned at an image plane or wherein each microlens of the array has an imaging side NA which is less than the NA of the microlens array.

16. (canceled)

17. The system according to claim 12, wherein a scanning direction is a direction lateral to the angle of the plane of light.

18. The system according to claim 17, wherein the illumination positions are stepped at a constant step size when generating the set of lightfield images.

19. The system according to claim 12, wherein the illumination angle is adjustable such that each lightfield image is associated with a unique combination of illumination position and illumination angle.

20. The system according to claim 12, wherein determining the intensity of light emitted from the object space associated with said voxel includes summing adjacent intensities within a predefined axial distance of the voxel.

21. The system according to claim 12, wherein the modules are further configured to: correct for apparent axial shifts of the apparent position of a voxel.

22. A computer readable storage medium for generating a volumetric image that stores instructions which, when executed by one or more processors of a computer, cause the computer to execute a plurality of modules stored in a memory, each module being able to execute a set of instructions, and wherein the modules comprise:
obtaining a set of lightfield images using a lightfield detection apparatus, each associated with an illumination slice corresponding to a lightsheet projected into the object space from a particular illumination position and at an illumination angle non-parallel to an optical axis of the lightfield detection apparatus, such that each voxel of a set of voxels associated with the object space is illuminated by at least one illumination slice, wherein each voxel is defined by a position in the object space; and
determining, for each voxel, an intensity of light emitted from the object space associated with said voxel using, in part, angular information captured by the lightfield images,
such that the determined intensities for each voxel of the set of voxels defines a volumetric image of emitted light intensity within the object space.
